(19) United States
(12) Patent Application Publication
(10) Pub. No.: US 2012/0194938 A1
(43) Pub. Date: Aug. 2, 2012

(54) METHOD OF WRITING INITIAL CLOCK PATTERNS AND MAGNETIC DISK DRIVE

(75) Inventor: NOBUYUKI SUZUKI, Kawasaki-shi (JP)

(73) Assignee: Kabushiki Kaisha Toshiba, Tokyo (JP)

(21) Appl. No.: 13/312,387

(22) Filed: Dec. 6, 2011

(30) Foreign Application Priority Data
Jan. 31, 2011 (JP) 2011-018961

(51) Int. Cl. G11B 5/09

(52) U.S. Cl. 360/51; G9B/5.033

(57) ABSTRACT

According to one embodiment, a method of writing initial clock patterns to a disk in a magnetic disk drive is disclosed. The method can write a first timing mark in a location on a circumference of a disk using a head based on a first clock signal corresponding to a frequency of oscillation of an oscillator. The method can adjust the frequency of oscillation of the oscillator or a rotational speed of a spindle motor by detecting, as a first timestamp, a time interval at which the first timing mark is read by the head from the disk so as to coincide with a second timestamp targeted by the first timestamp. In addition, the method can write the initial clock patterns to the disk based on a second clock signal corresponding to the adjusted frequency of oscillation or the adjusted rotational speed after the adjustment.

### CROSS-REFERENCE TO RELATED APPLICATIONS

This application is based upon and claims the benefit of priority from prior Japanese Patent Application No. 2011-018961, filed Jan. 31, 2011, the entire contents of which are incorporated herein by reference.

### FIELD

Embodiments described herein relate generally to a method of writing initial clock patterns and a magnetic disk drive.

### BACKGROUND

As is commonly known, a magnetic disk drive comprises a magnetic disk as a recording medium. In an explanation below, a magnetic disk is sometimes referred to as just a disk. On a disk, servo data (or servo patterns) is recorded. The servo data is used to position a head in a target position.

A recent magnetic disk drive has the function of writing servo data by itself to a disk (a so-called self-servo writing function). To perform self-servo writing, it is necessary to write initial clock patterns to a disk in a blank state (or a blank disk). The initial clock patterns are used as timing reference for self-servo writing.

In conventional technology, to write initial clock patterns to the blank disk, back electromotive force (more specifically, back electromotive force pulses generated based on back electromotive force) generated according to the rotation of a spindle motor is used. However, the back electromotive force generated according to the rotation of the spindle motor includes a lot of jitter components. Therefore, back electromotive force pulses generated based on the back electromotive force do not necessarily synchronize with the rotation of the spindle motor with high accuracy.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an exemplary configuration of a magnetic disk drive according to an embodiment;

FIG. 2 is a plan view showing an exemplary configuration of a disk enclosure shown in FIG. 1;

FIG. 3 is a block diagram showing an exemplary configuration of a read channel (RDC) shown in FIG. 1;

FIG. 4 is a block diagram showing an exemplary configuration of a phase-locked loop (PLL) unit shown in FIG. 3;

FIG. 5 shows a part of a flowchart to explain the procedure for writing initial clock patterns in the embodiment;

FIG. 6 shows the remaining part of the flowchart to explain the procedure for writing initial clock patterns in the embodiment; and

FIGS. 7A, 7B, 7C, 7D and 7E are diagrams to explain the writing of initial clock patterns in the embodiment.

### DETAILED DESCRIPTION

Various embodiments will be described hereinafter with reference to the accompanying drawings. In general, according to one embodiment, a method of writing initial clock patterns to a disk in a magnetic disk drive is disclosed. The initial clock patterns are used in self-servo writing. The disk is rotated by a spindle motor. The method can write a first timing mark in a location on a circumference of the disk using a head based on a first clock signal corresponding to a frequency of oscillation of an oscillator. The method can adjust the frequency of oscillation of the oscillator or a rotational speed of the spindle motor by detecting, as a first timestamp, a time interval at which the first timing mark is read by the head from the disk so as to coincide with a second timestamp targeted by the first timestamp. In addition, the method can write the initial clock patterns to the disk based on a second clock signal corresponding to the adjusted frequency of oscillation or the adjusted rotational speed after the adjustment.

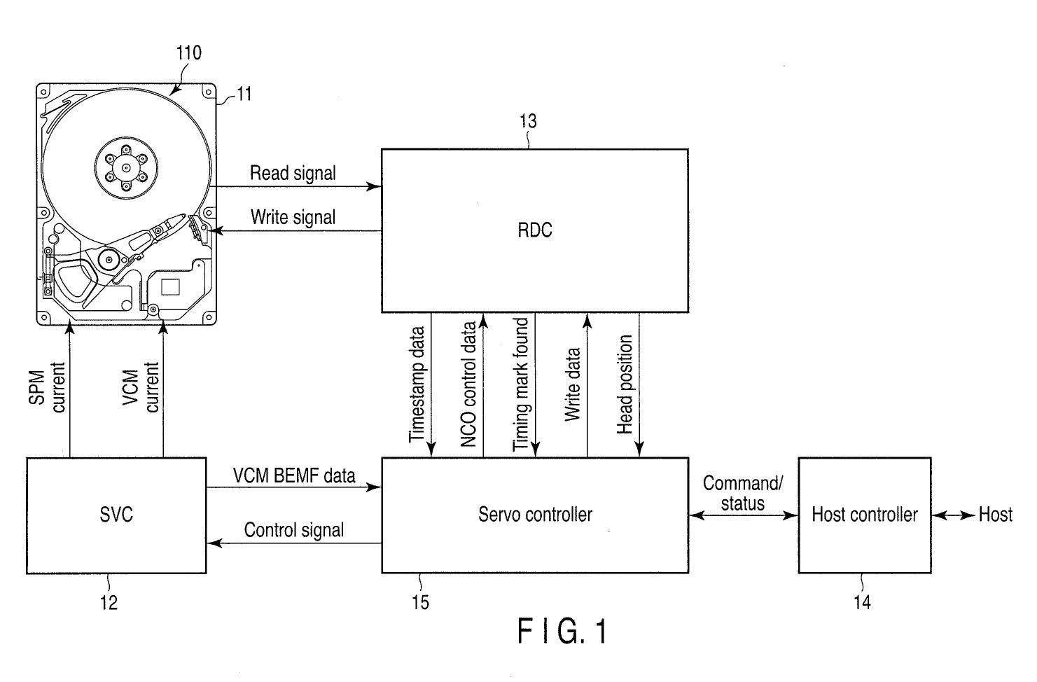

FIG. 1 is a block diagram showing an exemplary configuration of a magnetic disk drive according to an embodiment. The magnetic disk drive (HDD) of FIG. 1 comprises a disk enclosure 11, a servo combo driver (SVC) 12, a read channel (RDC) 13, a host controller 14, and a servo controller 15.

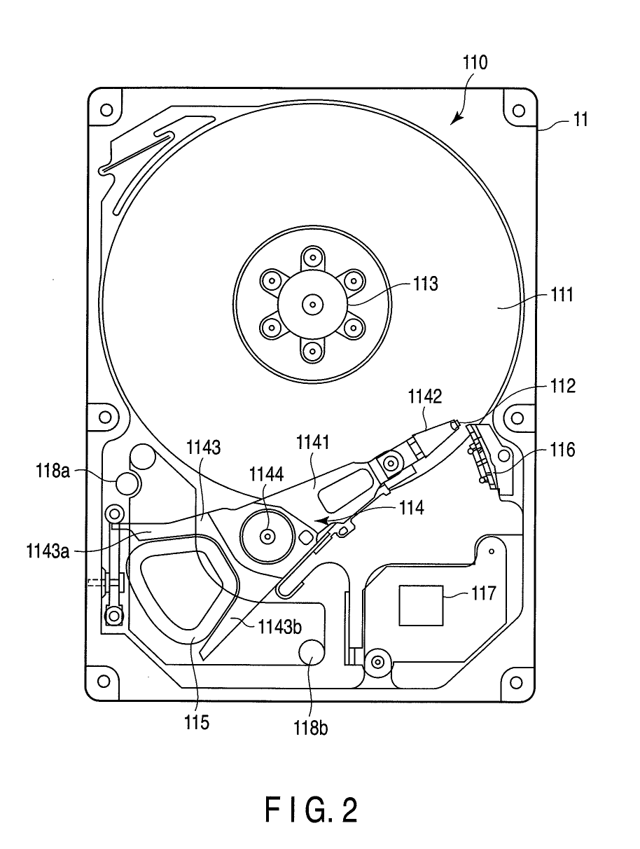

FIG. 2 is a plan view showing an exemplary configuration of the disk enclosure 11. In FIG. 2, the disk enclosure 11 comprises a head disk assembly (HDA) 110. The HDA 110 comprises a disk (magnetic disk) 111, a head (magnetic head) 112, a spindle motor (SPM) 113, an actuator 114, a voice coil motor (VCM) 115, a ramp 116, and a preamplifier 117.

The disk 111 is a magnetic recording medium. For example, one side of the disk 11 is a recording surface on which data is to be recorded magnetically. The disk 111, which is installed on the SPM 113, is rotated by the SPM 13 at a predetermined rotational speed. The SPM 113 is connected to the SVC 12 shown in FIG. 1.

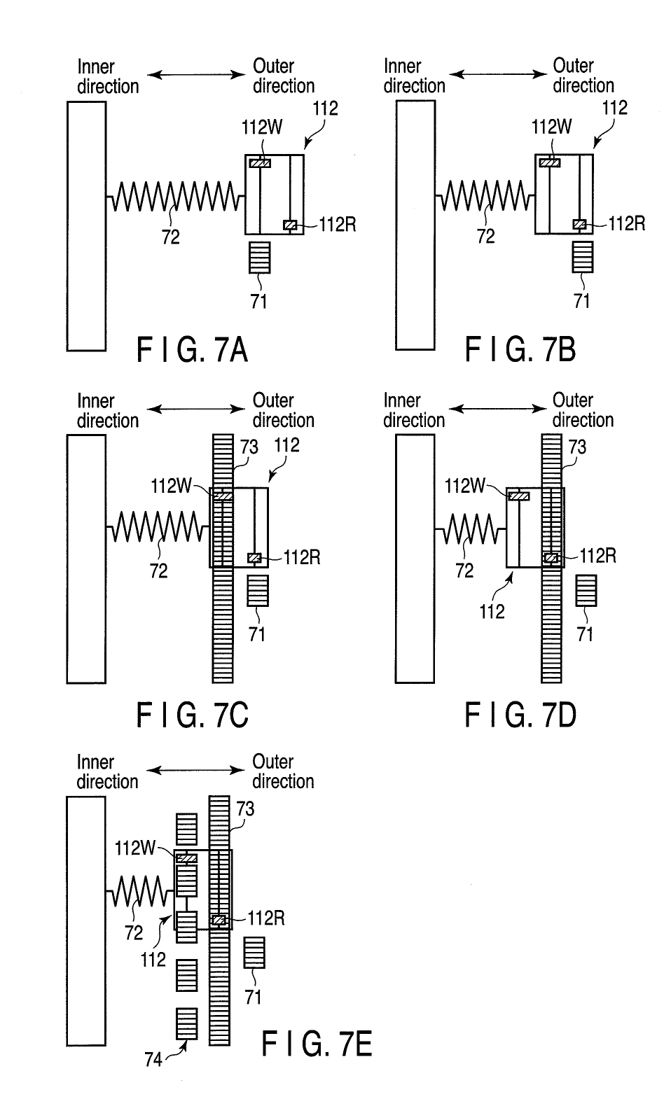

The head 112 is arranged in association with the recording surface of the disk 111. The head 112 includes a write element 112W and a read element 112R (see FIGS. 7A to 7E). The head 112 (write element 112W/read element 112R) is used to write data to the disk 111 and read data from the disk 111. In the embodiment, to simplify the explanation, the HDD having a single disk 111 is assumed. However, an HDD having a plurality of disks stacked one on top of another may be used. In the embodiment, one side of the disk 111 is a recording surface. However, both sides of the disk 111 may be recording surfaces, with heads being arranged in association with both recording surfaces in a one-to-one correspondence.

The actuator 114 comprises an arm (actuator arm) 1141. The head 112 is attached to the tip (more specifically, a head slider provided at the tip of a suspension 1142) of the suspension 1142 extended from the arm 1141 of the actuator 114. Such a structure of the suspension 1142 having the head 112 is called a head gimbal assembly (HGA). That is, the head 112 is mounted on the arm 1141 in the form of an HGA.

The actuator 114 further comprises a support frame 1143 and a pivot 1144. The support frame 1143 extends in the opposite direction of the arm 1141. The support frame 143, which is shaped like, for example, a V, comprises a frame end 1143a closer to the disk 111 and a frame end 1143b further away from the disk 111. The actuator 114 is supported so as to angularly move (rock) around the pivot 1144 freely. This enables the HGA mounted on the arm 1141 of the actuator 114 can move to an arbitrary radius position on the disk 111 and the ramp 116 in the radial direction of the disk 111.

The VCM 115 is a driving source of the actuator 114. That is, the actuator 114 is driven by the VCM 115. A coil (VCM coil) constituting a part of the VCM 115 is fixed to the support frame 1143 of the actuator 114. The VCM 115 is connected to the SVC 12 of FIG. 1.

The ramp 116 is arranged in a position on the outer edge side of and outside the disk 111. More specifically, the ramp 116 is arranged in a position closer to the outer edge of the disk 111 and on the transfer pathway of the HGA (more specifically, a lift tab at the tip of the HGA) of the actuator 114 outside the disk 111.

When the HDD shown in FIG. 1 is, for example, in a non-operating state, the HGA is moved to the ramp 116 to retract the head 112 from over the disk 11. The movement of the HGA from over the disk 111 to the ramp 116 is called unloading (or head unloading). In addition, when the HDD is, for example, in operation, the HGA is moved from the ramp 116 over the disk 111. The movement of the HGA from the ramp 116 over the disk 111 is called loading (or head loading).

An outer stopper 118a and an inner stopper 118b are fixed in predetermined positions of the disk enclosure 11. The outer stopper 118a is fixed in a position where the frame end 1143a of the support frame 1143 of the actuator 114 presses against the HGA when the HGA (head 112) is extracted to the ramp 116. The inner stopper 118b is fixed in a position where the frame end 1143b of the support frame 1143 of the actuator 114 presses against the HGA when head 112 is moved over the inner edge of the disk 111. The outer stopper 118a and inner stopper 118b are composed of, for example, an elastic member.

The preamplifier 117 is mounted on a flexible printed circuit board called an FPC. The preamplifier 117 is connected to the head 112 via the FPC. The preamplifier 117 amplifies a signal read by the head 112 (or a read signal). In addition, the preamplifier 117 converts a write signal transmitted from the RDC 13 into a write current. The write current is transmitted to the head 112.

In FIG. 1, the SVC 12, RDC 13, host controller 14, and servo controller 15 are mounted on a printed circuit board assembly (PCA). The PCA is mounted on the back surface of the disk enclosure 11 and therefore is not shown in FIG. 2.

The SVC 12, which is a motor driver composed of a combination of a VCM driver and an SPM driver, is, for example, a single-chip integrated circuit (IC). The SVC 12 is connected to the SPM 113 and VCM 115 shown in FIG. 2. In accordance with a control signal from the servo controller 15, the SVC 12 supplies (or applies) an SPM current (or an SPM voltage) and a VCM current (or a VCM voltage) to the SPM 113 and VCM 115, respectively. The SPM 113 and VCM 115 are driven in accordance with the SPM current and VCM current supplied from the servo controller 15, respectively. The SVC 12 comprises a back electromotive force (BEMF) detector (not shown). The BEMF detector detects BEMF of the VCM 115. As is commonly known, the BEMF of the VCM 115 is generated as a result of the VCM 115 being driven. The SVC 12 transmits VCM BEMF data representing the detected BEMF of the VCM 115 to the servo controller 15.

The RDC 13, which is also referred to as a read/write channel, processes a signal related to read/write. Specifically, the RDC 13 converts the read signal amplified by the preamplifier 117 into digital data and decodes read data from the digital data via a data path. The decoded read data is transmitted to the host controller 14 via a disk controller (not shown). In addition, the RDC 13 demodulates a head position signal included in servo data from the read data amplified by the preamplifier 117. The servo data is written to the disk 111 by a self-servo write function the HDD (more specifically, the servo controller 15 of the HDD) of FIG. 1 has. The RDC 13 further encodes write data transmitted from the disk controller and transmits the encoded write data (write signal) to the preamplifier 117.

The host controller 14 exchanges a signal with a host via an external interface. Specifically, the host controller 14 receives a command (a write command, a read command, or the like) transferred from the host via the external interface. The host uses the HDD of FIG. 1 as a storage device.

In addition, the host controller 14 issues a load command, an unload command, or the like in accordance with a received command or automatically. Furthermore, the host controller 14 controls the transfer of data (user data) between the host and the host controller 14. To simplify the explanation in FIG. 1, a configuration including the disk controller, that is, a configuration related to user data, is omitted.

The servo controller 15 has a self-servo write function as described above. The servo controller 15 also has a head positioning control function of positioning the head 112 in a target position on the disk 111. The servo controller 15 comprises an MPU, a memory, and an input/output circuit. In the memory, a control program executed by the MPU is stored, for example, in advance. The MPU reads the control program and runs it, thereby realizing the self-servo write function, head positioning control function, and others. Also in the memory, various constants used in processing performed by the MPU are stored. The VCM BEMF data from SVC 12, the head position signal from the RDC 13, a load command, an unload command, or the like from the host controller 14 are taken in by the MPU via the input/output circuit of the servo controller 15 and processed by the MPU.

The disk 111 in its initial state is in a blank state where no servo data has been written to the disk 111. In the embodiment, initial clock patterns for self-servo writing are written to the disk 111 in the blank state (or a blank disk) under the control the servo controller 15.

Hereinafter, a method of writing initial clock patterns to the blank disk 111 in the embodiment will be explained briefly. Actually, initial clock patterns are written by the head 112 in accordance with a write current corresponding to a write signal generated based on write data. In the explanation below, however, for the sake of simplicity, suppose the servo controller 15 writes initial clock patterns (and further a timing mark or timing marks), except for special cases.

The servo controller 15 writes initial clock patterns to the blank disk 111 as described below, mostly using the RDC 13 and the head 112. In the embodiment, the disk 111 until the initial clock patterns have been written is referred to as the blank disk 111 for descriptive purposes.

(1) The servo controller 15 writes a predetermined timing mark (a first timing mark) in an arbitrary location on a first concentric circle on the blank disk 111. Using the timing mark written on the blank disk 111 as an index mark, the RDC 13 measures time intervals (hereinafter, referred to as timestamps) at which the index mark (timing mark) is detected. The timestamps correspond to the rotational period of the SMP 113 and synchronize with the rotation of the SPM 113. In measuring the timestamps, a clock signal (hereinafter, referred to as a recovered clock signal) output from a numeric control oscillator (NCO) 1331 described later in the RDC 13 is used.

The servo controller 15 adjusts the frequency of oscillation of the NCO 1311 so that the value (timestamp data) obtained by measuring the timestamps may coincide with a target value. The NCO 1331 outputs a recovered clock signal and a write clock signal based on the adjusted frequency of oscillation.

(2) The servo controller 15 writes a predetermined number of predetermined timing marks (second timing marks) at predetermined intervals over a second concentric circle on the blank disk 111 based on the write clock signal output from the NCO 1331 (RDC 13).

(3) The servo controller 15 measures a repeatable runout of the predetermined number of timing marks written over the second concentric circle on the blank disk 111, using the RDC 13. The repeatable runout appears in synchronization with the rotation of the disk (in this case, blank disk 111).

(4) The servo controller 15 determines a corrected PLL operation variable by subtracting the measured repeatable runout from a PLL controlled variable explained later. The servo controller 15 supplies the corrected PLL operation variable as control data to the NCO 1331, thereby driving a PLL. By doing this, the servo controller 15 causes the PLL (NCO 1331) to generate a write clock signal that suppresses a repeatable runout. Based on the generated write clock signal, the servo controller 15 writes initial clock patterns to the blank disk 111.

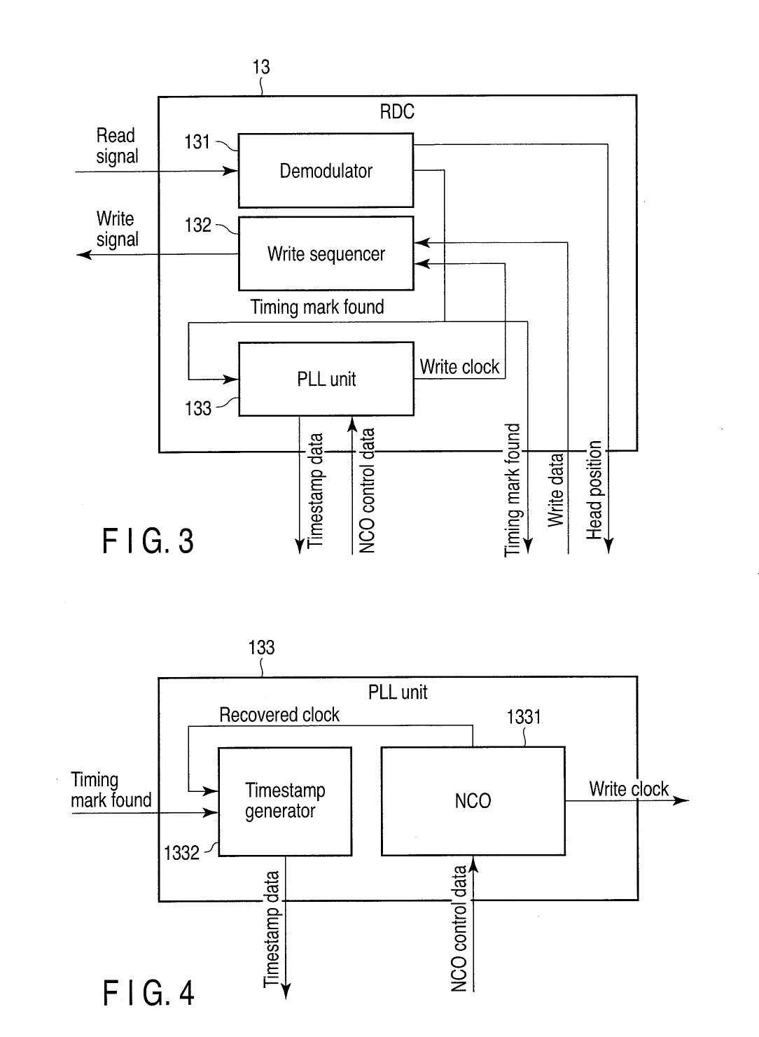

Next, a method of writing initial clock patterns to the blank disk 111 will be explained in detail. First, a configuration of the RDC 13 related to the writing of initial clock patterns will be explained with reference to FIGS. 3 and 4. FIG. 3 is a block diagram showing an exemplary configuration of the RDC 13. The RDC 13 comprises a timing mark demodulator (hereinafter, simply referred to as a demodulator) 131, a write sequencer 132, a phase-locked loop (PLL) unit 133.

The demodulator 131 demodulates a timing mark (or timing marks) from the read signal transmitted from the RDC 13. The demodulator 131 outputs a timing mark found signal that indicates that a timing mark (or timing marks) has been demodulated, that is, a timing mark (or timing marks) has been detected. The write sequencer 132 converts write data, such as a timing mark, transmitted from the servo controller 15 into a write signal based on a write clock signal output from the PLL unit 133. The PLL unit 133 detects the timestamps based on the timing mark found signal output from the demodulator 131. In addition, the PLL unit 133 generates a write clock signal based on using control data (NCO control data) as a PLL operation variable. The NCO control data is supplied by the servo controller 15 based on timestamp data that represents the timestamps detected by the PLL unit 133.

FIG. 4 is a block diagram showing an exemplary configuration of the PLL unit 133. The PLL unit 133 comprises an NCO 1331 and a timestamp generator 1332. The NCO 1331 uses NCO control data for controlling the NCO 1331 supplied by the servo controller 15 as a PLL operation variable, thereby oscillating at a corresponding frequency. Based on this frequency of oscillation, the NCO 1331 generates a write clock signal and a recovered clock signal. In the embodiment, the recovered clock signal is generated by frequency-dividing a clock signal of the frequency of oscillation (that is, a basic clock signal). The write clock signal is generated by frequency-dividing the recovered clock signal. However, the frequency of the recovered clock signal may be equal to that of the basic clock signal. In addition, the frequency of the write clock signal may be equal to that of the recovered clock signal.

The timestamp generator 1332 detects the timestamps based on the timing mark found signal output from the demodulator 131. The timestamp generator 1332 generates timestamp data that indicates the detected timestamps (that is, time intervals at which a timing mark was detected). The timestamp data is transmitted to the servo controller 15.

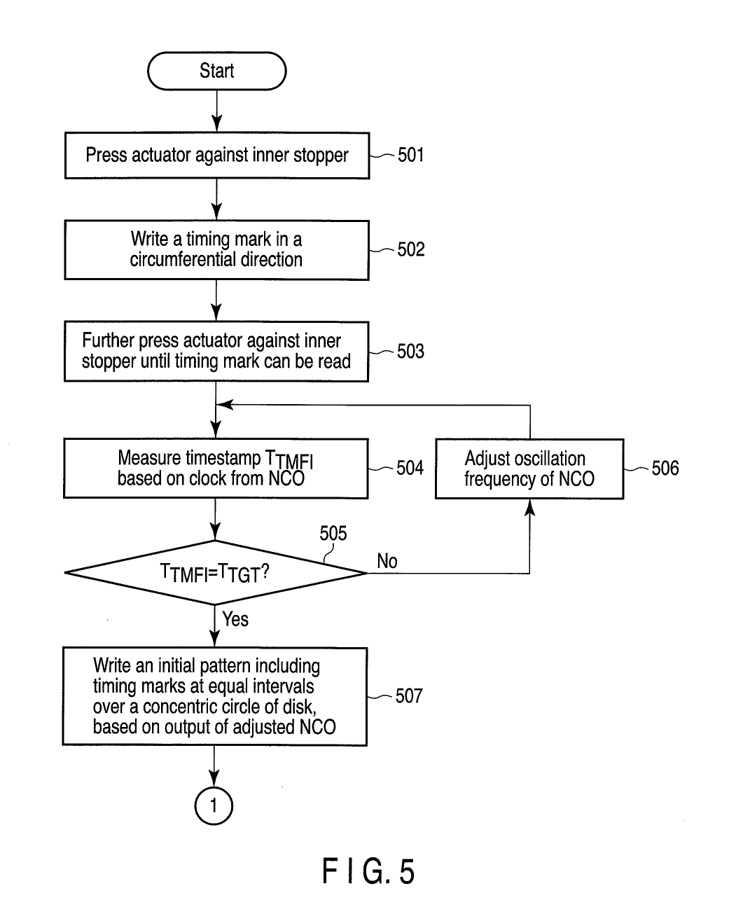

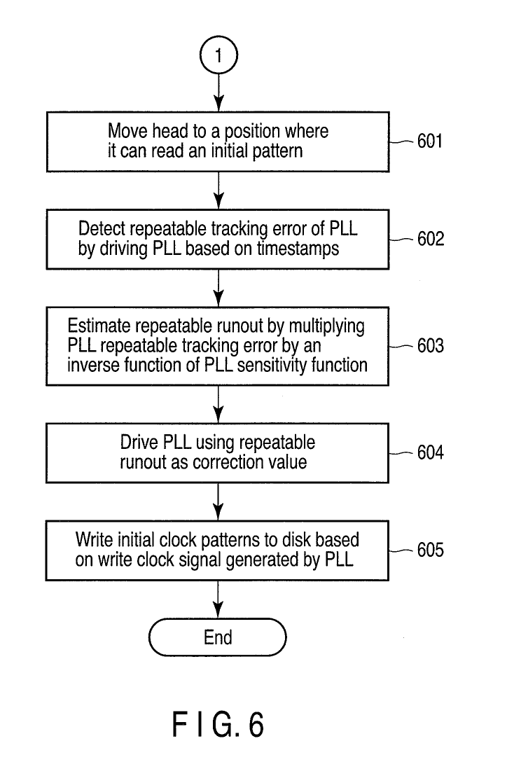

Next, a detailed procedure for a method of writing initial clock patterns to the blank disk 111 will be explained with reference to FIG. 5, FIG. 6, and FIGS. 7A to 7E. FIGS. 5 and 6 are flowcharts to explain the procedure for writing initial clock patterns. FIGS. 7A to 7E are diagrams to explain the way of writing initial clock patterns. In FIGS. 7A to 7E, the direction shown by the arrows is the radial direction of the blank disk 111. The direction perpendicular to the arrows is the circumferential direction of the blank disk 111. The leftward and rightward arrows represent an inner direction and an outer direction, respectively, explained later.

(Process 1)

The servo controller 15 starts up, via the SVC 12, the SPM 113 of the HDD in which the blank disk 111 is installed. At this time, suppose the head 112 (more specifically, the lift tab of the HGA on which the head 112 is mounted) has been retracted (unloaded) to the ramp 116. In this case, the servo controller 15 drives the VCM 115 via the SVC 12, thereby moving the head 112 from the ramp 116 to the inner diameter part of the blank disk 111. Here, the servo controller 15 moves the head 112 to the inner diameter part of the blank disk 111, while controlling the movement speed of the head 112. This control is called speed control. Servo data has not been written on the blank disk 111. Therefore, the servo controller 15 uses VCM BEMF data in place of servo data for speed control in moving the head 112 to the inner diameter part of the blank disk 111. The VCM BEMF data represents BEMF of the VCM 115 detected by a BEMF detector in the SVC 12. The reason why VCM BEMF data is used is that the VCM BEMF data, as is commonly known, corresponds to the movement speed of the head 112.

The servo controller 15 waits for the head 112 moved by the speed control to reach the inner diameter of the blank disk 111. Whether the head 112 has reached the inner diameter of the blank disk 111 can be determined based on, for example, the movement distance of the head 112. The movement distance of the head 112 is calculated based on the movement speed of the head 112 and time.

The servo controller 15 stores, in a memory (not shown), the value of the VCM current at the time when the head 112 reached the inner diameter of the blank disk 111. The VCM current is represented as a VCM current I_{vcminner} for positioning the head 112 in the inner diameter of the blank disk 111.

Next, the servo controller 15 calculates a first VCM current value (I_{vcminner} +ΔI1 ) by adding a predetermined first current increment ΔI1 to the I_{vcminner}). The first current increment ΔI1 has a polarity that causes the VCM 115 to move the head 112 toward the center of the blank disk 111 (hereinafter, referred to as in the inner direction). The direction in which the head 112 moves toward the outer diameter of the blank disk 111 is referred to as the outer direction. The calculated first VCM current value indicates a VCM current necessary to press, against the inner stopper 118b, the actuator 114 to which the head 112 positioned in the inner diameter of the blank disk 111 is attached (more specifically, the frame end 1143b of the support frame 1143 of the actuator 114).

Then, the servo controller 15 supplies a first VCM current shown by the first VCM current value to the VCM 115 via the SVC 12. Then, the VCM 115 presses the actuator 114 against the inner stopper 118b. That is, the servo controller 15 controls the VCM 115 via the SVC 12, thereby pressing the actuator 114 against the inner stopper 118b (block 501). A state where the actuator 114 is pressed against the inner stopper 118b in block 501 is called a first state. The inner stopper 118b is composed of an elastic member. Therefore, when the actuator 114 is pressed against the inner stopper 118b, the inner stopper 118b bends. That is, a bend (hereinafter, referred to as a stopper bend) 72 shown in FIG. 7A occurs in the inner stopper 118b. The head 112 moves in the inner direction for a distance corresponding to the stopper bend 72.

(Process 2)

In the first state, the servo controller 15 performs control in such a manner that a first timing mark 71 is written by the write element 112W in an arbitrary location on the circumference of the blank disk 111 facing the write element 112W of the head 112 as shown in FIG. 7A (block 502). This writing is controlled by the servo controller 15 giving write data corresponding to the first timing mark 71 to the RDC 3 (more specifically, the write sequencer 132 of the RDC 13).

The write sequencer 132 of the RDC 13 converts write data supplied by the servo controller 15 into a write signal in accordance with a write clock signal of a predetermined frequency output from the NCO 1331 of the PLL unit 133. The predetermined frequency is set so as to temporally divide a concentric circle on the blank disk 111 with a predetermined number of clocks when the blank disk 111 is rotated by the SPM 113 at a predetermined rotational speed. However, the actual rotational speed of the blank disk 111 does not necessarily synchronize with the write clock signal. Therefore, for the write clock signal to synchronize with the actual rotational speed of the blank disk 111, the frequency of oscillation of the NCO 1331 to determine the frequency of the write clock signal is adjusted as follows.

The write signal converted by the write sequencer 132 is transmitted to the preamplifier 117. The preamplifier 117 converts the write signal into a write current and supplies the write current to the write element 112W of the head 112. The write element 112W generates a write magnetic field corresponding to the write current supplied by the preamplifier 117. As a result, a magnetic pattern corresponding to the write magnetic field is recorded as the first timing mark 71 in a position on the blank disk 111 facing the write element 112W.

(Process 3)

In the embodiment, the positions of the write element 112W and read element 112R are located away for each other in the radial direction of the blank disk 111 as shown in, for example, FIG. 7A. That is, the positions of the write element 112W and read element 112R shift in the radial direction of the blank disk 111. Therefore, in order for the read element 112R to read the first timing mark 71 written on the blank disk 111 by the write element 112W, the head 112 has to be moved from the position in the first state for a distance corresponding to the shift. In the embodiment, the position of the read element 112R is shifted in the outer direction with respect to the write element 112W. In this case, it is necessary to make the stopper bend 72 greater than in the first state to move the head 112 in the inner direction.

Therefore, the servo controller 15 further presses the actuator 114 against the inner stopper 118b, while increasing the VCM current in steps of a second current increment ΔI2 until the read element 112R can read the first timing mark 71 (hereinafter, this state being referred to as a second state) (block 503). That is, the servo controller 15 performs the operation of moving the head 112 in the first state (that is, the state of FIG. 7A) in the inner direction in steps of an infinitesimal distance (a so-called micro-jog operation) until the second state has been reached. The details of the micro-jog operation are as follows. The second current increment ΔI2 may be equal to or differ from the first current increment ΔI1.

First, the servo controller 15 supplies a second VCM current obtained by adding the second current increment ΔI2 to the first VCM current to the VCM 115 via the SVC 12. Then, the VCM 115 further presses the actuator 114 against the inner stopper 118b. That is, the servo controller 15 drives the VCM 115 with the second VCM current, thereby pressing the actuator 114 strongly against the inner stopper 118b. As a result, the stopper bend 72 becomes greater than in the state shown in FIG. 7A. This causes the head 112 to move for an infinitesimal distance in the inner direction.

In this state, however, suppose the read element 112R of the head 112 has not reached the circumference of the blank disk 111 including the location where the first timing mark 71 has been written in block 502. That is, suppose the first timing mark 71 cannot be read by the read element 112R. In this case, the second current increment ΔI2 is further added to the VCM current at that time (here, a second VCM current). As described above, in block 503, the VCM current is increased from the second VCM current in steps of the second current increment ΔI2 until the read element 112R can read the first timing mark 71 (this state being called a second state) as shown in FIG. 7B.

In the state of FIG. 7B, when the first timing mark 71 has been read by the read element 112R, the demodulator 131 of the RDC 13 outputs a timing mark found signal that indicates that the first timing mark 71 has been detected. When having received the timing mark found signal, the servo controller 15 makes sure that the head 112 is in the second state. Then, the servo controller 15 terminates block 503 (micro-jog operation). As described above, the servo controller 15 moves the head 112 stepwise in the inner direction until the RDC 13 has reported the detection of the timing mark.

(Process 4)

The timing mark found signal output from the demodulator 131 of the RDC 13 is input not only to the servo controller 15 but also to the PLL unit 133 of the RDC 13. The timing mark found signal is a binary signal that transits from a first logical state to a second logical state each time the demodulator 131 demodulates (or detects) the timing mark (here, the first timing mark 71) and returns to the first logical state after a predetermined time has elapsed. That is, the timing mark found signal is composed of a pulse train corresponding to the detection of the timing mark.

The timestamp generator 1332 of the PLL unit 133 measures a time interval (or a timing mark interval) T_{TMFI} at which the demodulator 131 detects the timing mark as a timestamp T_{TMFI} based on the timing mark found signal (block 504). Here, the timing mark is the first timing mark 71 written in the arbitrary location on the first concentric circle on the blank disk 111. Therefore, the timestamp T_{TMFI} measured in block 504 represents a time interval from a first time point when the first timing mark 71 was read by the read element 112R (or detected by the demodulator 131) until a second time point when the first timing mark 71 is read again (or detected again) in the next rotation of the blank disk 111. The timestamp T_{TMFI} is measured by counting the number of clocks at timing mark intervals based on a recovered clock signal output from the NCO 1331.

The timestamp generator 1332 comprises a modulo counter and a latch. The modulo counter, which operates based on the recovered clock signal from the NCO 1331, counts the number of clocks in the recovered clock signal. The latch, which operates based on the timing mark found signal, holds a value of the modulo counter at the time when the timing mark found signal transited to the second logical state (that is, at the time when a timing mark was detected). The modulo counter is a counter that returns to zero when a preset count value (setting value) has been reached. The count value constitutes a system of residues with the setting value as a modulus. The timestamp generator 1332 with this configuration measures a timestamp T_{TMFI}. The timestamp generator 1332 (RDC 13) transmits timestamp data representing the measured timestamp T_{TMFI} to the servo controller 15.

(Process 5)

When having received timestamp data from the RDC 13, the servo controller 15 compares the measured timestamp T_{TMFI} shown by the timestamp data with a target time interval (hereinafter, referred to as a target timestamp) T_{TGT}. Then, the servo controller 15 determines whether the measured timestamp (a first timestamp) T_{TMFI} coincides with the target timestamp (a second timestamp) T_{TGT} (block 505). Here, suppose the servo controller 15 determines whether T_{TMFI} coincides with T_{TGT} in a range of the measurement accuracy of the timestamp _{TMFI} or a predetermined error range.

(Process 6)

If the determination in block 505 has shown “No,” the servo controller 15 adjusts the frequency of oscillation of the NCO 1331 included in the PLL unit 133 of the RDC 13 so as to eliminate the deviation of the timestamp T_{TMFI} from the target timestamp T_{TGT} (block 506). Such an adjustment of the frequency of oscillation of the NCO 1331 is made by supplying NCO control data from the servo controller 15 to the NCO 1331.

(Process 7)

Suppose the timestamp T_{TMFI} coincides with the target timestamp T_{TGT} as a result of the adjustment of the frequency of oscillation of the NCO 1331 by the servo controller 15 (YES in block 505). Then, as shown in FIG. 7C, the servo controller 15 performs control in such a manner that the write element 112W writes an initial pattern 73 over the second concentric circle on the blank disk 111 (block 507). The initial pattern 73 includes the predetermined number of second timing marks at the predetermined intervals. The predetermined number of second timing marks may or may not be consecutive.

To write the initial pattern 73, a write clock signal (hereinafter, referred to as an adjusted write clock signal) output by the NCO 1331 whose frequency of oscillation has been adjusted is supplied to the write sequencer 132 of the RDC 13. The servo controller 15 supplies a string of second timing marks constituting the initial pattern 73 as write data to the write sequencer 32. The write sequencer 132 converts the write data into a write signal based on the adjusted write clock signal. As a result, the initial pattern 73 synchronizing with the adjusted write clock signal is written over the second concentric circle on the blank disk 111. That is, the predetermined number of second timing marks synchronizing with the adjusted write clock signal are written at the predetermined intervals over the second concentric circle on the blank disk 111.

As described above, the positions of the write element 112W and read element 112R are shifted in the radial direction of the blank disk 111. Therefore, the position on the radius of the blank disk 111 where the first timing mark 71 written in block 502 is present differs from the position on the radius of the blank disk 111 where the initial pattern 73 including the second timing marks written in block 507 is present. That is, the two kinds of timing marks differ in the position on the radius of the blank disk 111 and therefore can be distinguished from each other. If the positions of the write element 112W and read element 112R are not shifted in the radial direction of the blank disk 111, for example, the head 112 may be moved in the radial direction of the blank disk 111 before block 507 is executed.

(Process 8)

As shown in FIG. 7D, the servo controller 15 further moves the head 112 in the inner direction by a micro-jog operation until the read element 112R can read the initial pattern 73 (block 601). Block 601 is executed as block 503 is. In block 601, the actuator 114 is pressed more strongly against the inner stopper 118b than in block 503. Therefore, the stopper bend 72 increases more than in FIGS. 7B and 7C.

(Process 9)

When the head 112 has been moved to a position where the head 112 can read the initial pattern 73, the read element 112R of the head 112 reads the predetermined number of second timing marks included in the initial pattern 73 sequentially in a period when the blank disk 111 rotates one revolution. The demodulator 131 of the RDC 13 demodulates a predetermined number of second timing marks sequentially read by the read element 112R from a read signal and outputs a timing mark found signal corresponding to the detection of the second timing marks.

The timestamp generator 1332 included in the PLL unit 133 of the RDC 13 measures time intervals at which timing marks are detected by the demodulator 131 as timestamps based on the timing mark found signal from the demodulator 11 as described above. The timing marks detected by the demodulator 131 are the predetermined number of second timing marks included in the initial pattern 73 written over the second concentric circle on the blank disk 111. Therefore, time intervals at which adjacent second timing marks are detected are measured as timestamps (third timestamps).

Each time the timing mark found signal shows the detection of the timing mark (second timing mark), the timestamp generator 1332 measures the corresponding timestamp. The timestamp generator 1332 generates timestamp data representing the measured timestamps and transmits the timestamp data to the servo controller 15.

The servo controller 15 drives the PLL using, as an input, the timestamp data transmitted by the timestamp generator 1332, thereby detecting a repeatable tracking error of the PLL (block 602). The details of the detection of the PLL repeatable tracking error are as follows.

First, based on the timestamp data, the servo controller 15 calculates a phase error in the timestamps (third timestamps) detected by the timestamp generator 1332 with respect to a target timestamp (a fourth timestamp). Next, the servo controller 15 uses the calculated phase error as the input of the PLL to apply a filter operation for constituting the PLL to the calculated phase error. By the filter operation, the servo controller 15 calculates a PLL operation variable.

The servo controller 15 transmits the calculated PLL operation variable as NCO control data to the NCO 1331 included in the PLL unit 133 of the RDC 13. The NCO 1331 operates using the NCO control data supplied by the servo controller 15 as a PLL operation variable. This configures a PLL system where the phase error is used as a controlled variable and the NCO control data is used as a PLL operation variable.

Next, the servo controller 15 finds a repeatable tracking error of the PLL system configured as described above. The repeatable tracking error is calculated by averaging the PLL controlled variable over a plurality of revolutions on the blank disk 111 each time a timing mark corresponding to a rotational angle of the blank disk 111 is detected. A control error can be separated into a reproducible repetitive component depending on a rotational angle position and a random component independent of a rotational angle position. The random component is produced by noise generated by the disk 111 or a circuit (a circuit mounted on the printed board unit). The repetitive component is generated by a shift in the positional relationship between the disk 111 and write element 112W at the time when a timing mark is written, or a shift in the recording position on the disk 111 caused by a shift in the write clock signal with respect to the rotation of the disk 111, that is, by so-called missregistration. The repetitive component (that is, repeatable runout) can be corrected by executing blocks 603 and 604 described below.

(Process 10)

Having detected a PLL repeatable tracking error, the servo controller 15 estimates a repeatable runout by multiplying the repeatable tracking error by an inverse function of the PLL sensitivity function (1/sensitivity function) (block 603). The inverse function of the PLL sensitivity function is obtained by actually measuring the PLL sensitivity function and finding its inverse number for each frequency.

(Process 11)

Next, the servo controller 15 uses the obtained repeatable runout as a correction value, thereby obtaining a corrected PLL operation variable (block 604). In block 604, the servo controller 15 supplies the corrected PLL operation variable as NCO control data to the NCO 1331, thereby driving the PLL (that is, the corrected or reconfigured PLL) (block 604). That is, the servo controller 15 drives the PLL using the obtained repeatable runout as a correction value. The corrected PLL operation variable is obtained as follows.

First, the repeatable runout corresponds to a shift from an ideal position in the circumferential direction of the blank disk 111 for each timing mark written on the blank disk 111 corresponding to the rotational angle of the blank disk 111. Therefore, the servo controller 15 functions as a PLL compensator in driving the PLL. The servo controller 15 uses a repeatable runout of a corresponding rotational angle as a correction value and subtracts the repeatable runout from the detected phase error. The servo controller 15 acquires data obtained by subtracting a repeatable runout of the corresponding rotational angle from the detected phase error as a corrected PLL operation variable. The servo controller 15 supplies the obtained PLL operation variable as NCO control data to the NCO 1331 as described above, thereby driving the PLL. This makes it possible to prevent a repeatable runout from being input to the PLL. Accordingly, it is possible to generate a write clock signal unaffected by a repeatable runout, that is, a regular write clock signal synchronizing with the rotation of the disk 111.

(Process 12)

Next, the servo controller 15 drives the write sequencer 132 based on the write clock signal generated by the PLL (NCO 1331) (block 605). That is, the servo controller 15 performs control in such a manner that the write element 112W writes the target initial clock patterns 74 over, for example, a third concentric circle on the blank disk 111 as shown in FIG. 7E (block 605). At this time, the head 112 is in a position where the read element 112R of the head 112 can read second timing marks included in the initial pattern 73.

The initial clock patterns 74 written on the blank disk 111 in block 605 synchronize with the write clock signal generated by the PLL (NCO 1331) corrected in block 604. Therefore, nonuniformity caused by a repeatable runout has been removed from the initial clock patterns 74 differently from the initial pattern 73 written on the blank disk 111.

With the embodiment, the frequency of the write clock signal is adjusted so that the time intervals (timestamps) T_{TMFI} detected by reading the first timing mark 71 written once on the first concentric circle on the blank disk 111 may coincide with the target timestamp T_{TGT}. This makes it possible to generate a write clock signal synchronizing with the rotation of the blank disk 111 with high accuracy. In addition, such a write clock signal can be generated without using the BEMF of the SPM 113. Therefore, to write the initial clock patterns 74 to the blank disk 111, a circuit that generates a BEMF pulse corresponding to the BEMF of the SPM 113 and inputs it to the PLL is not necessary, which enables component costs to be decreased.

Furthermore, with the embodiment, a repeatable runout is obtained based on the time intervals (third timestamps) at which the second timing marks written at the predetermined intervals over the second concentric circle on the blank disk 111 are detected. Initial clock patterns are written to the blank disk 111 based on a write clock signal from which the influence of the obtained repeatable runout has been removed. Therefore, with the embodiment, the accuracy of the initial clock patterns, particularly the accuracy concerning a repeatable runout, is improved remarkably. Moreover, the embodiment does not include an element that tries writing patterns in an open loop, that is, an element where the result of writing patters depends on chance. Therefore, according to the embodiment, necessary initial clock patterns can be written on the blank disk 111 in a predetermined time.

Even when the positional relationship between the write element 112W and read element 112R is the reverse of that in the embodiment, the initial clock patterns 74 can be written to the blank disk 111 with high accuracy as in the embodiment. In this case, for example, the first timing mark 71 may be written on the blank disk 111 with the head 112 in the position shown in FIG. 7D, and the initial clock patterns 74 may be written on the blank disk 111 with the head 112 in the position shown in FIG. 7A. That is, the direction of the movement of the head 112 using the stopper bend 72 may be set as the reverse of that in the embodiment.

In the embodiment, the initial pattern 73 is written over the second concentric circle on the blank disk 111 based on the write clock signal whose frequency is adjusted in a loop from block 504 to block 506 (block 507). The initial pattern 73 includes the predetermined number of second timing marks at the predetermined intervals. However, block 507 and blocks 601 to 604 may be omitted and the initial clock patterns 74 may be written based on a write clock signal whose frequency has been adjusted in a loop from block 504 to block 506. In this case, although the influence of a repeatable runout has not been eliminated, the initial clock patterns 74 may be written based on a write clock signal synchronizing with the rotation of the blank disk 111 with high accuracy.

In addition, with the embodiment, to synchronize the rotation of the blank disk 111 with the write clock signal, the frequency of the write clock signal is adjusted. However, instead of adjusting the frequency of the write clock signal, the rotational speed of the blank disk 111, that is, the rotational speed of the SPM 113, may be adjusted. According to at least one embodiment explained above, it is possible to provide a method of writing initial clock patterns to a blank disk based on a write clock signal synchronizing with the rotation of the spindle motor with high accuracy and a magnetic disk drive.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of writing initial clock patterns to a disk in a magnetic disk drive, the initial clock patterns used in self-servo writing, the disk being rotated by a spindle motor, the method comprising:
writing by a head a first timing mark in a location on a circumference of the disk based on a first clock signal corresponding to a frequency of oscillation of an oscillator;
adjusting the frequency of oscillation of the oscillator or a rotational speed of the spindle motor based on whether a first timestamp coincides with a second timestamp, the first timestamp corresponding to a time interval between when the first timing mark is read by the head a first time and when the first timing mark is read by the head a second time, and the second timestamp corresponding to a first target time interval for the first timing mark; and
writing the initial clock patterns to the disk based on a second clock signal corresponding to the adjusted frequency of oscillation or the adjusted rotational speed after the adjustment.

2. The method of claim 1, further comprising:
writing an initial pattern over a concentric circle on the disk based on the second clock signal, the initial pattern comprising second timing marks at predetermined intervals;
detecting third timestamps corresponding to time intervals during which the second timing marks are read sequentially by the head from the disk;
obtaining a repeatable runout of the second timing marks based on a phase error in the third timestamps determined based on a fourth timestamp corresponding to a second target time interval for the second timing marks; and
supplying to the oscillator corrected control data used to control the oscillator, the corrected control data obtained by subtracting the obtained repeatable runout from the phase error.

3. The method of claim 2, wherein obtaining the repeatable runout comprises:
detecting a repeatable tracking error of a PLL by driving the PLL, the PLL using the phase error as an input and comprising the oscillator; and
obtaining the repeatable runout based on the repeatable tracking error.

4. The method of claim 3, wherein the repeatable runout is obtained by multiplying the repeatable tracking error by an inverse function of a sensitivity function of the PLL.

5. The method of claim 4, wherein:
the phase error is used as a controlled variable of the PLL; and
a corrected PLL operation variable of the PLL is used as the corrected control data, the corrected PLL operation variable calculated by subtracting the repeatable runout from the phase error.

6. The method of claim 1, further comprising pressing an actuator against an inner stopper by driving a voice coil motor, the actuator supporting the head,
wherein the first timing mark is written with the actuator pressed against the inner stopper.

7. The method of claim 6, further comprising moving the head by changing a bend of the inner stopper with the actuator pressed against the inner stopper, wherein the bend is changed by changing a current supplied to the voice coil motor or a voltage applied to the voice coil motor,
wherein the initial clock patterns are written after the movement of the head.

8. A magnetic disk drive comprising:
a disk configured to be rotated by a spindle motor;
a signal generator configured to generate a first clock signal corresponding to a frequency of oscillation of an oscillator, the first clock signal comprising a clock signal used to write data to the disk by a head;
a timestamp generator configured to generate timestamp data corresponding to a first timestamp by detecting, as the first timestamp, a time interval at which a first timing mark is read by the head from the disk; and
a controller configured to control the writing of initial clock patterns used in self-servo writing to the disk based on the generated timestamp data,
wherein the controller is further configured to:
write, by the head, the first timing mark in an arbitrary place on a concentric circle on the disk based on the first clock signal,
adjust the frequency of oscillation of the oscillator or a rotational speed of the spindle motor based on whether the first timestamp coincides with a second timestamp, the second timestamp corresponding to a first target time interval for the first timing mark, and
write the initial clock patterns to the disk based on a second clock signal corresponding to the adjusted frequency of oscillation or the adjusted rotational speed after the adjustment.

9. The magnetic disk drive of claim 8, wherein:
the timestamp generator is further configured to detect third timestamps corresponding to time intervals during which second timing marks are read sequentially by the head from the disk; and
the controller is further configured to:
write an initial pattern over a concentric circle on the disk based on the second clock signal, the initial pattern comprising the second timing marks at predetermined intervals,
obtain a repeatable runout of the second timing marks based on a phase error in the third timestamps determined based on a fourth timestamp corresponding to a second target time interval for the second timing mark, and
supply to the oscillator corrected control data used to control the oscillator, the corrected control data obtained by subtracting the obtained repeatable runout from the phase error.

10. The magnetic disk drive of claim 9, wherein the controller is further configured to:
detect a repeatable tracking error of a PLL by driving the PLL, the PLL using the phase error as an input and comprising the oscillator, and
obtain the repeatable runout based on the repeatable tracking error.

11. The magnetic disk drive of claim 10, wherein the repeatable runout is obtained by multiplying the repeatable tracking error by an inverse function of a sensitivity function of the PLL.

12. The magnetic disk drive of claim 11, wherein:
the phase error is used as a controlled variable of the PLL; and
a corrected PLL operation variable of the PLL is used as the corrected control data, the corrected PLL operation variable calculated by subtracting the repeatable runout from the phase error.

13. The magnetic disk drive of claim 8, wherein:
the controller is further configured to press an actuator against an inner stopper by driving a voice coil motor, the actuator supporting the head,
wherein the first timing mark is written with the actuator pressed against the inner stopper.

14. The magnetic disk drive of claim 13, wherein:
the controller is further configured to move the head by changing a bend of the inner stopper with the actuator pressed against the inner stopper;
the bend is changed by changing a current supplied to the voice coil motor or a voltage applied to the voice coil motor; and
the initial clock patterns are written after the movement of the head.
